(19) United States
(12) Patent Application Publication
(10) Pub. No.: US 2026/0150960 A1
(43) Pub. Date: Jun. 4, 2026

(54) BRISTLE GOODS MANUFACTURING MACHINE

(71) Applicant: Zahoransky AG, Todtnau (DE)

(72) Inventors: Iñaki ESPINOSA, Logroño (ES); Victor RIOJA, Logroño (ES); Matthias SCHUBNELL, Logroño (ES); Javier Gutiérrez NEILA, Mansilla de la Sierra (ES)

(73) Assignee: Zahoransky AG, Todtnau (DE)

(21) Appl. No.: 19/353,716

(22) Filed: Oct. 9, 2025

(30) Foreign Application Priority Data
Dec. 2, 2024 (EP) 24383302.7

(51) Int. Cl. A46D 3/06; A46D 3/08; B23Q 7/04

(52) U.S. Cl. CPC A46D 3/067; A46D 3/085; A46D 3/087; B23Q 7/04

(57) ABSTRACT

A bristle goods manufacturing machine (1) is provided having a carousel (2) on which are provided at least three holders (5) for receiving bristle goods bodies (6), which holders are disposed successively in the rotation direction of the carousel (2), and with a carousel drive (3) by way of which the carousel (2) is rotatably driven about a rotation axis (4). The bristle goods manufacturing machine (1) has at least one drilling station (7) with a drilling tool (8), and at least one stuffing station (9) with a stuffing tool (10), and at least one loading and/or unloading station (11) for loading and/or unloading the holders (5), and a feed axis (13) of the drilling tool (8) and a stuffing axis (14) of the stuffing tool (10) are aligned parallel to one another.

### CROSS-REFERENCE TO RELATED APPLICATIONS

This application claims priority from European Patent Application No. 24383302.7, filed Dec. 2, 2023, which is incorporated herein by reference as if fully set forth.

### TECHNICAL FIELD

The invention relates to a bristle goods manufacturing machine with a carousel on which are disposed at least three holders for receiving bristle goods bodies, which holders are disposed successively in the rotation direction of the carousel, and with a carousel drive by way of which the carousel is rotatably driven about a rotation axis.

### BACKGROUND

Bristle goods manufacturing machines of this type are also referred to as carousel machines and enable the industrial production of bristle goods, such as brushes or brooms, as used in various embodiments, for example in a household.

US 4 854 645 A discloses a machine for manufacturing brushes, which comprises a rotatable drum with lateral faces, which extend parallel to the rotation axis, for transporting brush bodies to different processing stations, a plurality of brush body holders which are pivotably disposed on the lateral faces of the drum, and means for pivoting the brush body holders relative to the drum.

WO 2021/204853 A1 discloses a machine for manufacturing brushes, with a stuffing station in which at least one stuffing tool is provided, a drilling station in which more drilling tools are provided than are stuffing tools in the stuffing station, and a transport system which has a plurality of carrier units which are movable in a mutually independent manner and carry in each case two or more clamping devices for brush main bodies and can be actuated from the drilling station onward to the stuffing station.

DE 21 63 692 A1 discloses a brush manufacturing machine with drilling and stuffing tools and a rotatably mounted clamping means carrier which is equipped with at least two double arms.

US 2 433 192 A discloses a further embodiment of a machine for manufacturing brushes.

Carousel machines are often used for the production of bristle goods, as they require comparatively little space due to their compact construction mode. The holders for receiving bristle goods bodies of the bristle goods to be manufactured are disposed on the carousel and can be supplied by the latter to different processing stations of the bristle goods manufacturing machine for processing.

Bristle goods manufacturing machines of this type typically have a drilling station with a drilling tool, and a stuffing station with a stuffing tool, and a loading and/or unloading station for loading and/or unloading the holders on the carousel. In the loading and/or unloading station, bristle goods bodies can be inserted into the holders on the carousel for processing. By rotating the carousel, a bristle goods body is then first fed to the drilling station with the drilling tool located therein. Holes for receiving bristle bundles can be drilled in the bristle goods bodies with the aid of the drilling tool. In the subsequent stuffing station, bristle bundles can be stuffed into the previously drilled holes of the bristle goods bodies with the aid of a stuffing tool. The bristle bundles are fixed in the holes of the bristle goods bodies with the aid of anchors. Thereafter, the bristle goods are moved by the carousel into the loading and/or unloading station and can be retrieved in the latter.

Conventional bristle goods manufacturing machines of the type mentioned at the outset require a variety of actuators for positioning the tools for processing the bristle goods bodies, and for positioning the holders and the carousel. The conventional bristle goods manufacturing machines are comparatively expensive and complex in terms of production and operation, not least due to the number of actuators provided.

### SUMMARY

It is therefore an object of the invention to provide a cost-effective and bristle goods manufacturing machine of the type mentioned at the outset.

In order to achieve the object, a bristle goods manufacturing machine with one or more of the features disclosed herein is provided. In order to achieve the object, in particular a bristle goods manufacturing machine is provided with a carousel on which are provided at least three holders for receiving bristle goods bodies, which holders are disposed successively in the rotation direction of the carousel, and with a carousel drive by way of which the carousel is rotatably driven about a rotation axis. The bristle goods manufacturing machine has at least one drilling station with a drilling tool, at least one stuffing station with a stuffing tool, and at least one loading and/or unloading station for loading and/or unloading the holders. It is provided according to the invention that a feed axis of the drilling tool and a stuffing axis of the stuffing tool are aligned parallel to one another.

The feed axis of the drilling tool is the axis along which the drilling tool is pushed into the material of the bristle goods bodies when drilling the holes. A rotation axis of a drill of the drilling tool is congruent with the feed axis.

The stuffing axis of the stuffing tool extends in the direction in which the stuffing tool stuffs bristle bundles into the previously drilled holes in the bristle goods bodies.

The mutually parallel alignment of the feed axis of the drilling tool and the stuffing axis of the stuffing tool makes it possible to dispose the drilling tool and the stuffing tool on a common stand and/or to be moved by a common actuator to an initial position from which both tools perform the processing of bristle goods bodies offered up.

Overall, this can reduce the number of expensive parts, such as the number of actuators that the bristle goods manufacturing machine has. This enables a bristle goods manufacturing machine of this type to be provided in a particularly economical manner.

The rotation axis of the carousel can be disposed in a plane between the feed axis of the drilling tool and the stuffing axis of the stuffing tool. The rotation axis of the carousel can moreover be disposed in a plane which is parallel to the feed axis of the drilling tool and the stuffing axis of the stuffing tool.

Particularly preferably, the rotation axis of the carousel, the feed axis of the drilling tool, and the stuffing axis of the stuffing tool are horizontally aligned.

The carousel is imparted a symmetrical structure which facilitates that processing forces are absorbed in a particularly simple manner when the holders for the bristle goods bodies are disposed on the carousel so as to be uniformly distributed about the rotation axis of the carousel. It simplifies the absorption of processing forces that occur when creating holes in the bristle goods bodies and when stuffing bristle bundles into the bristle goods bodies, when the holders are disposed on the carousel so as to be uniformly distributed about the rotation axis of the carousel, and the rotation axis of the carousel is disposed in a plane between the feed axis of the drilling tool and the stuffing axis of the stuffing tool. It can be particularly advantageous in this context when the feed axis of the drilling tool and the stuffing axis of the stuffing tool have the same spacing from the plane within which the rotation axis of the carousel is disposed. In the best case, the processing forces that occur when processing the bristle goods bodies located in the holders can thus cancel each other out.

The carousel drive can be specified to fix the carousel in its rotational position by way of a holding torque. The carousel drive holds the carousel in place and can absorb the processing forces that act on the carousel when the bristle goods bodies located in the holders are processed. Alternatively or additionally, it can be expedient when the bristle goods manufacturing machine has a locking device for the carousel. The locking device can be used to prevent rotation of the carousel when processing the bristle goods bodies located in the holders. The locking device can be configured as a mechanical locking device. The locking device can comprise a locking bolt and a plurality of locking notches which are distributed about the rotation axis on the carousel and in which the locking bolt can engage in the locking position in order to fix the carousel in a rotational position. The locking device in the locking position can then prevent the carousel from being rotated from its position due to the processing of the bristle goods bodies located in the holders and the processing forces which are introduced into the carousel in the process.

In one embodiment of the bristle goods manufacturing machine, the drilling station and the stuffing station are disposed on one side of the carousel, and the loading and/or unloading station is disposed on a side opposite in terms of the rotation axis of the carousel. The rotation axis of the carousel then extends between the loading and/or unloading station on the one hand, and the drilling station and the stuffing station on the other.

According to the invention, the bristle goods manufacturing machine has a pivoting device with a pivot axis and a pivot drive for the carousel, wherein the pivot axis is aligned orthogonally to the rotation axis of the carousel.

With the aid of the pivoting device it is possible to swivel the carousel as a whole conjointly with the holders thereon. Thus, the bristle goods bodies located in the holders can be presented to the drilling tool and the stuffing tool in different angular positions for processing. The parallel alignment of the feed axis of the drilling tool and the stuffing axis of the stuffing tool enables the conjoint pivoting positioning of the bristle goods bodies in the holders due to the pivoting movement of the carousel as a whole about the pivot axis aligned orthogonally to the rotation axis of the carousel. In this way, separate pivot drives assigned to the respective holders can be avoided. This also enables a reduction in expensive actuators.

The pivoting device enables the alignment of the bristle goods bodies clamped to the holders for manufacturing bristle goods with oblique bristle bundles.

The bristle goods manufacturing machine can also have a horizontal adjustment device having a horizontal adjustment drive and a horizontal guide which is oriented orthogonally to the feed axis of the drilling tool and the stuffing axis of the stuffing tool and along which the carousel can be positioned.

The horizontal adjustment device enables the carousel to be positioned as a whole together with the holders disposed thereon and the bristle goods bodies located thereon relative to the drilling tool and the stuffing tool for processing the bristle goods bodies. The positioning of all holders and thus all bristle goods bodies in the holders along the horizontal guide can then be performed by only a single horizontal adjustment drive. In this way, separate horizontal adjustment drives assigned to the individual holders can be avoided. This also makes it possible to be able to manufacture and offer such a bristle goods manufacturing machine at a reasonable price.

In order to be able to position the bristle goods bodies for processing also in a vertical direction relative to the drilling tool and to the stuffing tool, the bristle goods manufacturing machine can have a lifting device with a lifting drive and a vertically oriented lifting axis. The carousel as a whole can be height-adjustable along the lifting axis. The height adjustment of all holders and all the bristle goods bodies located thereon can then be performed by only a single lifting drive. This also enables savings in terms of individual separate actuators that would otherwise be required for each individual holder on the carousel.

In a particularly advantageous embodiment of the bristle goods manufacturing machine it is provided that the latter has a slide on which the drilling tool and the stuffing tool are conjointly disposed. With the aid of the slide, the drilling tool and the stuffing tool can be moved conjointly to an initial position relative to the holders on the carousel and thus relative to the bristle goods bodies located in the holders. From the initial position, processing of the bristle goods bodies with the drilling tool and the stuffing tool can then take place.

The slide can be mounted so as to be linearly displaceable in a slide guide. The slide guide can be oriented parallel to the drilling tool feed axis and parallel to the stuffing axis of the stuffing tool. The bristle goods manufacturing machine can have a slide drive by way of which the slide is linearly displaceable in the slide guide. This enables a fully automated conjoint positioning of the stuffing tool and the drilling tool in the respective initial position required for the processing of the bristle goods bodies, from which processing of the provided bristle goods bodies can then be performed. It can be advantageous in this context when the drilling of holes on a bristle goods body presented to the drilling tool and the stuffing of bristle bundles in corresponding holes of a bristle goods body presented to the stuffing tool take place synchronously.

The carousel can have a rotary feedthrough which enables a supply, for example an electrical and/or pneumatic supply and/or a supply of signals, of functional units, in particular of holders, clamps, sensors and/or drives, disposed on the carousel. In this way, for example, the holders on the carousel can be supplied with energy and/or with signals. The rotary feedthrough enables the carousel to be rotated in only one direction, even without change of direction, in order to transport the bristle goods bodies from station to station.

If supply lines and/or signal lines are connected directly to functional units, for example to the holders and/or holder drives, which are disposed on the carousel, after rotating the carousel by, for example 240° in one direction, it may be necessary to reverse the carousel by likewise 240° in the opposite direction in order to avoid damage to the supply lines and/or signal lines. Such restrictions are not to be taken in to account in a rotary feedthrough that enables the supply of the functional units disposed on the carousel.

The carousel can thus have a rotary feedthrough for the electrical and/or pneumatic supply and/or supply of signals of functional units disposed on the carousel, such as, for example, holder drives explained in more detail below.

The holders on the carousel can be mounted on the carousel so as to be rotatable about a holder rotation axis which is oriented parallel to the rotation axis of the carousel. Each holder can be specified to receive two or three or more bristle goods bodies.

Due to the holders being mounted so as to be rotatable about their holder rotation axes oriented parallel to the rotation axis of the carousel, bristle goods bodies located on the holders can be aligned relative to the drilling tool and the stuffing tool for processing. In this way, oblique holes for receiving oblique bristle bundles can be generated, without having to change an axial alignment of the drilling tool and of the stuffing tool. This can reduce the complexity in machines required to produce bristle goods with correspondingly oblique bristle bundles.

When the holders are specified to receive two or three or more bristle goods bodies, the bristle goods manufacturing machine can be populated with a correspondingly higher number of bristle goods bodies.

The bristle goods manufacturing machine can have at least one holder drive. In one embodiment of the bristle goods manufacturing machine, this at least one holder drive is disposed outside the carousel and is thus an external holder drive. In another embodiment of the bristle goods manufacturing machine, this at least one holder drive is disposed on the carousel. With the aid of the at least one holder drive, one or a plurality of holders on the carousel can be rotated about their respective holder rotation axis in order to position the bristle goods bodies located on the holders relative to the drilling tool and relative to the stuffing tool. With the aid of the at least one holder drive, a plurality of bristle goods bodies located on a holder can be presented successively to the drilling tool or the stuffing tool for processing. A holder drive of this type enables changing of a bristle goods body to be processed on a holder that can receive more than only one bristle goods body.

The carousel can have a bearing plate on which the holders are rotatably mounted. The bearing plate can be assigned a counter bearing plate. The holders can be disposed between the bearing plate and the counter bearing plate, and be rotatably mounted on both. The bearing plate and the counter bearing plate can be connected to one another by way of at least one connecting strut. Corresponding bearings for rotatably mounting the holders can be disposed in the bearing plate as well as in the counter bearing plate.

In one embodiment of the bristle goods manufacturing machine, the bearing plate can be rotatable about the rotation axis of the carousel by the carousel drive of the carousel. The carousel drive for driving can be connected to the carousel, in particular to the bearing plate of the carousel, by way of a gearbox.

In one embodiment of the bristle goods manufacturing machine, at least one holder drive is disposed on the bearing plate. A holder drive of this type is then a conjointly rotating holder drive which is disposed on the carousel. Each holder on the bearing plate can be assigned its own holder drive.

In another embodiment of the bristle goods manufacturing machine, at least one holder drive is provided as an external holder drive. In this context, an external holder drive is such a holder drive, which is not disposed on the carousel and does not rotate conjointly with the latter. A drive movement of the external holder drive can be transmitted to the holder assigned thereto by way of a gearbox. In one embodiment of the bristle goods manufacturing machine, a plurality of holders are driven by one holder drive. A holder drive of this type can be disposed either on the carousel, for example on the bearing plate of the carousel mentioned above, or outside the carousel as an external holder drive.

If the bristle goods manufacturing machine has a holder drive which is assigned to a plurality of holders, the holder drive for driving can be connected to at least two, preferably to all holders, by way of a gearbox configured as a transfer case. A transfer case of this type can comprise, for example, gearwheels, in particular spur gearwheels, and/or friction wheels and/or belt pulleys and drive belts.

In one embodiment of the bristle goods manufacturing machine, the holders have in each case at least one clamp for bristle goods bodies and/or bristle goods. The bristle goods manufacturing machine can have an operating unit which is specified for decoupling a drive connection to a holder located in the loading and/or unloading station, and/or for opening a clamp of a holder located in the loading and/or unloading station.

With the aid of the operating unit, a holder located in the loading and/or unloading station and in particular its clamp can thus be opened in order to remove a completed bristle goods and/or to populate the holder with a bristle goods body to be processed.

In particular, if all holders on the carousel for driving are connected to a single holder drive, for example by means of a transfer case, it can be expedient when the operating unit, as previously mentioned, is also specified for decoupling a drive connection to the holder located in the loading and/or unloading station. The drive connection to the holder located in the loading and/or unloading station can then be temporarily decoupled for populating the holder with a bristle goods body and/or for retrieving a completed bristle goods.

The loading and/or unloading station can have a gripper for retrieving completed bristle goods and/or for populating the holders with bristle goods bodies. This enables the fully automatic and particularly safe population of the holders with bristle goods bodies and also the automatic and safe retrieval of completed bristle goods.

### BRIEF DESCRIPTION OF THE DRAWINGS

The invention will now be described in more detail by means of exemplary embodiments, but is not limited to these exemplary embodiments. Further exemplary embodiments are derived by combining the features of individual or multiple claims with one another and/or by combining individual or multiple features of the exemplary embodiments.

In the figures:

FIG. 1 shows a perspective illustration of a first bristle goods manufacturing machine with a motor-driven carousel on which are disposed three pivotally mounted holders for bristle goods bodies, wherein the holders with bristle goods bodies located thereon are movable to three different stations of the bristle goods manufacturing machine, and wherein one of the stations is a drilling station and a second one of the stations is a stuffing station.

FIG. 2 shows a lateral view of the bristle goods manufacturing machine shown in FIG. 1.

FIG. 3 shows a further perspective view of the bristle goods manufacturing machine shown in the preceding figures.

FIG. 4 shows a top view of the bristle goods manufacturing machine shown in FIGS. 1 to 3.

FIG. 5 shows a perspective illustration of a further bristle goods manufacturing machine, the construction of the latter corresponding to the construction of the bristle goods manufacturing machine shown in FIGS. 1 to 4, but its holders being specified to receive three bristle goods bodies, as opposed to the bristle goods manufacturing machine shown in FIGS. 1 to 4.

FIG. 6 shows a top view of the bristle goods manufacturing machine shown in FIG. 5.

FIG. 7 shows a perspective illustration of a bristle goods manufacturing machine with a carousel and a drilling and stuffing station for manufacturing toilet brushes, wherein each holder for bristle goods bodies is assigned its own holder drive in order to rotate the respective holder on a bearing plate of the carousel.

FIG. 8 shows a perspective illustration of the bristle goods manufacturing machine shown in FIG. 7 with a view toward a rear side of the bearing plate of the carousel, so as to visualize a rotary feedthrough for supply and/or signal lines.

FIG. 9 shows a perspective illustration of a bristle goods manufacturing machine with a carousel and a drilling and stuffing station for manufacturing toilet brushes, wherein the bristle goods manufacturing machine has a common holder drive for the holders on the carousel, by way of which the holders can be rotated on a bearing plate of the carousel.

FIG. 10 shows a perspective illustration of the bristle goods manufacturing machine shown in FIG. 9 with a view toward a front side of the bearing plate of the carousel.

FIG. 11 shows a perspective illustration of a bristle goods manufacturing machine with a carousel and a drilling and stuffing station for manufacturing toilet brushes, wherein disposed on a bearing plate of the carousel on which the holders for the bristle bodies are rotatably mounted is one holder drive for each holder, by way of which the respective holder can be rotated on the bearing plate of the carousel.

FIG. 12 shows a front view of the bristle goods manufacturing machine shown in FIG. 11, with a view toward a front side of the bearing plate of the carousel, so as to visualize the positions of the holder drives.

FIG. 13 shows a partially sectional lateral view of the bristle goods manufacturing machine shown in FIGS. 1 to 4, so as to visualize a gearbox of the bristle goods manufacturing machine, by way of which the carousel drive with the bearing plate of the carousel, and the holder drives with the holders for the bristle goods bodies rotatably mounted on the bearing plate of the carousel, are connected for driving.

### DETAILED DESCRIPTION

If no explicit reference is made to a specific exemplary embodiment in the following description of the figures, the explanations refer to all exemplary embodiments shown in the figures.

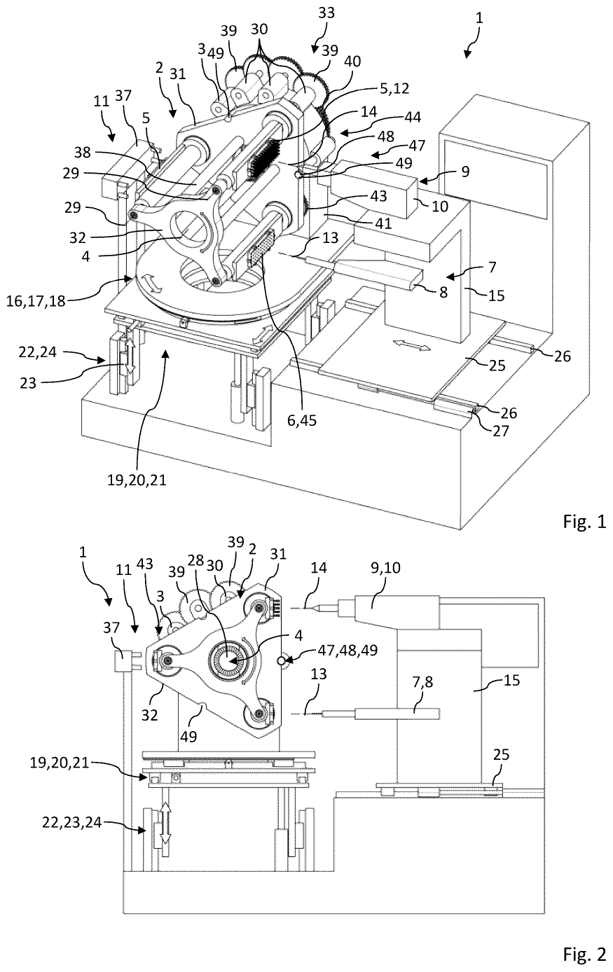

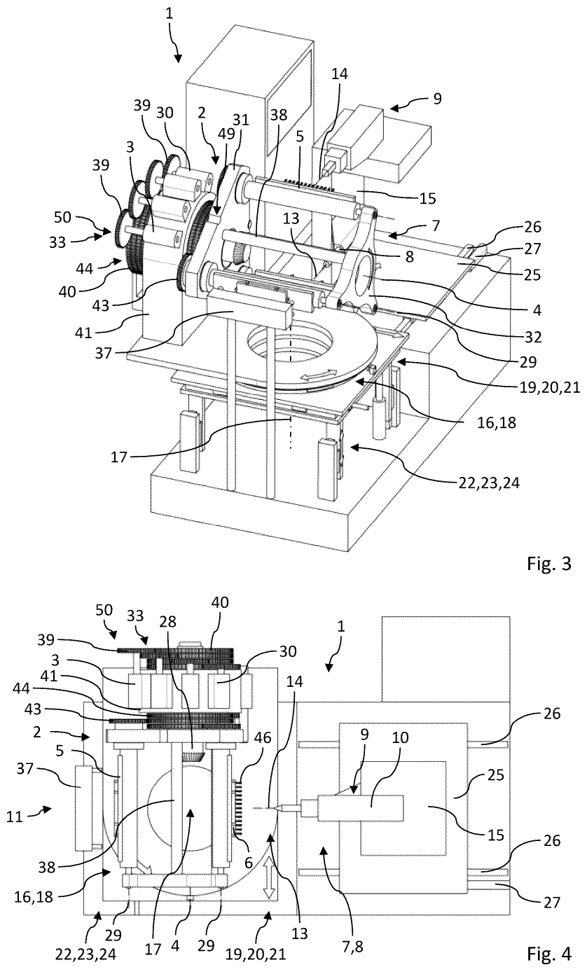

FIGS. 1-4 and 13, 5 and 6, 7 and 8, 9 and 10, and 11 and 12 show different embodiments of bristle goods manufacturing machines which are in each case as an entity identified by the reference sign 1.

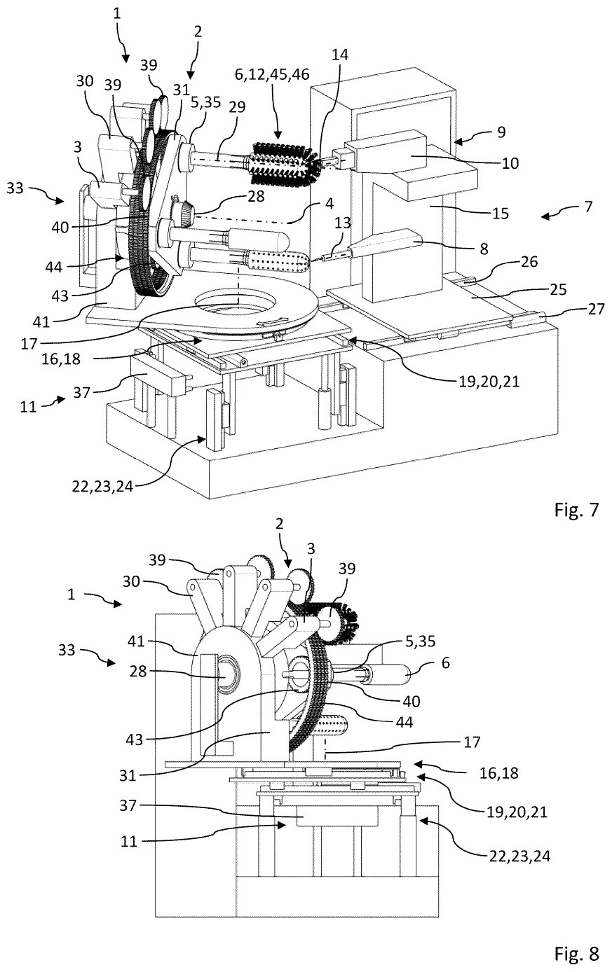

The bristle goods manufacturing machines 1 shown in FIGS. 1-6 and 13 are specified for manufacturing elongate brushes or brooms. The bristle goods manufacturing machines 1 shown in FIGS. 7-12 are specified for manufacturing long-handle toilet brushes.

Each bristle goods manufacturing machine 1 shown in the figures has a carousel 2 on which are provided three holders 5, disposed successively in the rotation direction of the carousel 2, for receiving bristle goods bodies 6. Each bristle goods manufacturing machine 1 has a carousel drive 3 in the form of an electric motor by way of which the carousel 2 is rotatably driven about a rotation axis 4.

Each bristle goods manufacturing machine 1 shown has a drilling station 7 with a drilling tool 8, and a stuffing station 9 with a stuffing tool 10, and a loading and/or unloading station 11 for bristle goods bodies 6 and bristle goods 12.

With the aid of the drilling tool 8, holes 45 are drilled into offered-up bristle goods bodies 6 in the drilling station 7. In the subsequent stuffing station 9, bristle bundles 46 are stuffed into the holes 45 generated in the preceding drilling station 7 and anchored in the bristle goods body 6 with the aid of the stuffing tool 10.

The figures show that a feed axis 13 of the drilling tool 8 and a stuffing axis 14 of the stuffing tool 10 are parallel to one another in all bristle goods manufacturing machines 1 shown.

The drilling tool 8 and the stuffing tool 10 of each of the bristle goods manufacturing machines 1 shown are disposed on a common stand 15 of the respective bristle goods manufacturing machine 1.

The rotation axis 4 of the carousel 2 of each bristle goods manufacturing machine 1 shown is disposed in a plane between the feed axis 13 of the drilling tool 8 and the stuffing axis 14 of the stuffing tool 10, wherein this plane is aligned parallel to the feed axis 13 and the stuffing axis 14.

The rotation axis 4 of the carousel 2, the feed axis 13 of the drilling tool 8 and the stuffing axis 14 of the stuffing tool 10 are aligned horizontally. This is the case with each of the bristle goods manufacturing machines 1 shown in the figures.

The holders 5 are disposed on the carousel 2 so as to be uniformly distributed about the rotation axis 4 of the respective carousel 2 in the bristle goods manufacturing machines 1 shown.

All bristle goods manufacturing machines 1 have a pivoting device 16 with a pivot axis 17 and a pivot drive 18 for the respective carousel 2. The pivot axis 17 is aligned orthogonally to the rotation axis 4 of the carousel 2 and thus vertically aligned.

By means of a horizontal adjustment device 19 of the respective bristle goods manufacturing machine 1, the carousel 2 can be positioned horizontally relative to the two tools 8 and 10.

The respective horizontal adjustment device 19 has a horizontal adjustment drive 20 and a horizontal guide 21 which is oriented orthogonally to the feed axis 13 of the drilling tool 8 and to the stuffing axis 14 of the stuffing tool 10. The carousel 2 can be positioned along the horizontal guide 21 relative to the drilling tool 8 and the stuffing tool 10 in order to be able to align the bristle goods bodies 6 located in the holders 5 relative to the drilling tool 8 and/or the stuffing tool 10 for processing.

Each bristle goods manufacturing machine 1 shown moreover has a lifting device 22. Each lifting device 22 comprises a lifting drive 23 and a vertically oriented lifting axis 24 along which the respective carousel 2 is height-adjustable for the vertical positioning of the bristle goods bodies 6 located in the holders 5 relative to the drilling tool 8 and the stuffing tool 10.

Each bristle goods manufacturing machine 1 has a slide 25 on which the drilling tool 8 and the stuffing tool 10 are conjointly disposed. The stand 15 which has already been mentioned previously and on which the drilling tool 8 and the stuffing tool 10 are disposed, is set up on this slide 25.

The slide 25 is mounted so as to be linearly displaceable in a slide guide 26. The slide guide 26 is oriented parallel to the feed axis 13 of the drilling tool 8 and parallel to the stuffing axis 14 of the stuffing tool 10. With the aid of the slide 25, the drilling tool 8 and the stuffing tool 10 can be moved to an initial position relative to the carousel 2, from which the processing of the bristle goods bodies 6 located on the holders 5 is performed. Depending on the angular position in which the bristle goods bodies 6 on the holders 5 are presented with the aid of the carousel 2, it may be necessary to adjust the initial position from which the processing of the bristle goods bodies 6 in the holders 5 is performed with the aid of the drilling tool 8 and the stuffing tool 10. This can then be take place easily and effectively with the aid the linearly displaceable slide 25. In order to be able to mechanically adjust the respective slide 25, each of the bristle goods manufacturing machines 1 shown comprises a slide drive 27.

For supplying the functional units located on the carousel 2, for example the holders 5 or the holder drives 30 explained in more detail below, each carousel 2 has a rotary feedthrough 28. The rotary feedthrough 28 allows the electrical and/or pneumatic supply and/or the supply of signals of functional units located on the carousel 2, such as holders 5 or also holder drives 30.

In all bristle goods manufacturing machines 1 shown, the holders 5 are in each case mounted on the carousel 2 so as to be rotatable about a holder rotation axis 29 which is oriented parallel to the rotation axis 4 of the respective carousel 2.

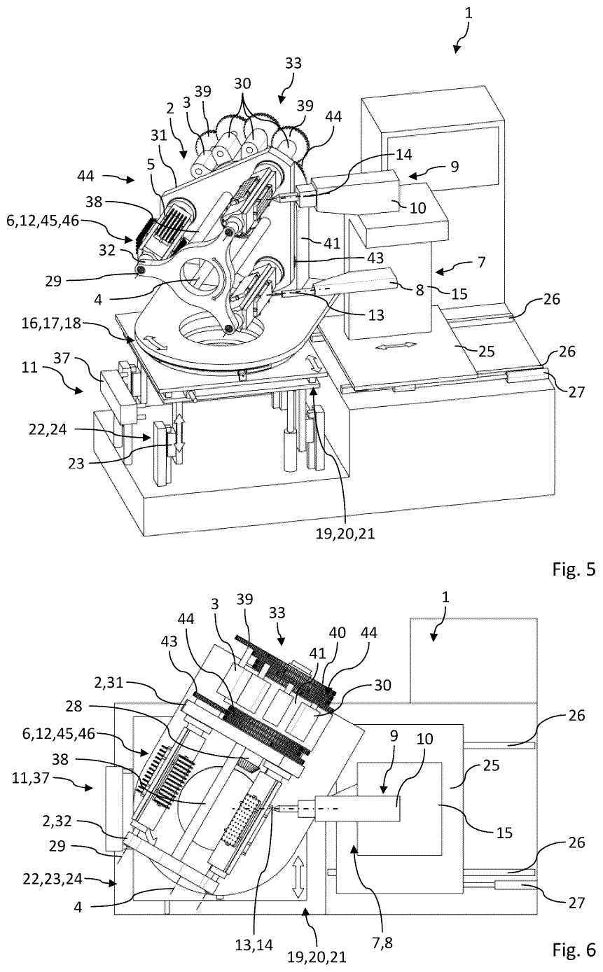

In the bristle goods manufacturing machine 1 shown in FIGS. 5 and 6, the holders 5 are specified to receive in each case three bristle goods bodies 6. The holders 5 of the bristle goods manufacturing machine 1 shown in FIGS. 5 and 6 thus have in each case three clamping slots for bristle goods bodies 6. By rotating the holders 5 about their holder rotation axis 29, the bristle goods bodies 6 clamped at the different clamping slots can be presented to the tools, specifically the drilling tool 8 and the stuffing tool 10, for processing.

The bristle goods manufacturing machines 1 shown in FIGS. 1-8 and 13 have in each case one holder drive 30 for each rotatably mounted holder 5, which holder drive is not disposed on the respective carousel 2 and can be referred to as an external holder drive 30. The external holder drives 30 for driving are connected to the rotatable holders 5 by way of a gearbox 33 which comprises the gearwheels 39 and 43 as well as the idler gearwheels 44. The gearboxes of the bristle goods manufacturing machines 1 shown in FIGS. 1 to 6 and 12 moreover comprise gearbox shafts 50 which penetrate a bearing block 41 of the respective bristle goods manufacturing machine 1.

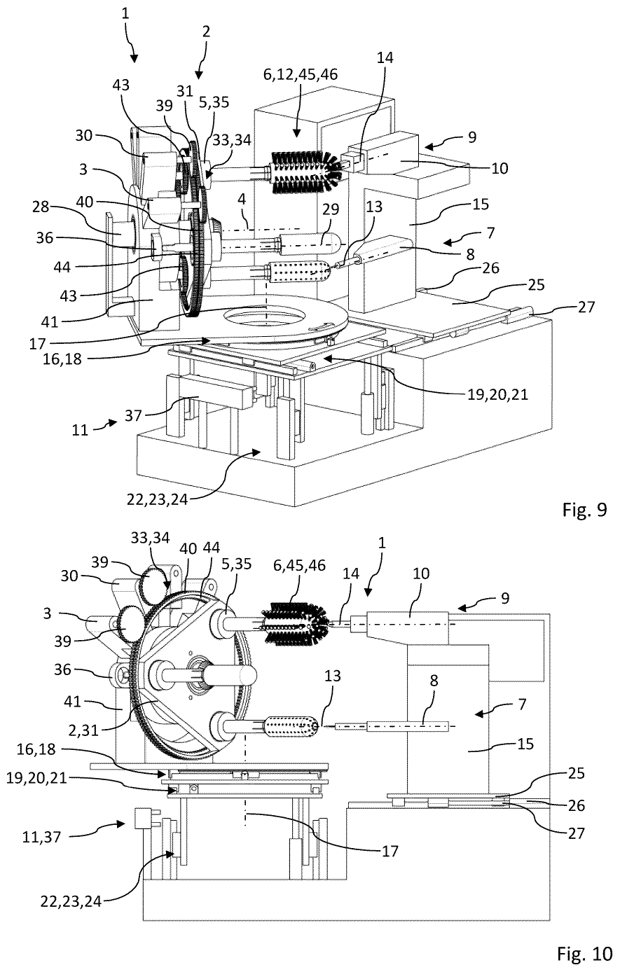

In the bristle goods manufacturing machine 1 shown in FIGS. 9 and 10, a single external holder drive 30 is provided, which for driving is connected to all three holders 5 provided on the carousel 2 by way of a gearbox 33 that is configured as a transfer case 34. The holders 5 of this bristle goods manufacturing machine 1 have gearwheels 43 which for driving are connected to the gearwheels 39 of the holder drives 30 by way of the idler gearwheel 44.

Each of the carousels 2 shown comprises a bearing plate 31 on which the holders 5 are rotatably mounted. In the bristle goods manufacturing machines 1 shown in FIGS. 1-6 and 13, the bearing plate 31 is assigned a counter bearing plate 32. The holders 5 are disposed between the bearing plate 31 and the counter bearing plate 32 and are rotatably mounted on them. The bearing plate 31 and the counter bearing plate 32 are connected to one another by way of connecting struts 38.

The bearing plates 31 of the carousels 2 shown in the figures are rotated about the rotation axis 4 of the carousel 2 by the carousel drive 3 of the respective carousel 2. In all the bristle goods manufacturing machines 1 shown in the figures, the bearing plates 31 for driving are connected to the respective carousel drive 3 by way of a gearbox 33.

In the bristle goods manufacturing machine 1 shown in FIGS. 1-4 and 13, this gearbox 33 comprises interconnected gearwheels 39 and 40. The gearwheel 39 is disposed on an output shaft of the carousel drive 3, while the gearwheel 40 is connected to the bearing plate 31 by way of a gearbox shaft 50. The gearwheel 39 transmits a drive movement of the carousel drive 3 to the bearing plate 31 of the carousel 2, which is connected to said gearwheel, by way of the gearbox shaft 50.

The bristle goods manufacturing machine 1 shown in FIGS. 5 and 6 has a correspondingly constructed gearbox 33 which likewise comprises gearwheels 39 and 40, a plurality of gearbox shafts 50 and idler gearwheels 44 and serves for transmitting the drive movement of the carousel drive 3 to the bearing plate 31 of the carousel 2.

In the bristle goods manufacturing machines 1 shown in FIGS. 7-12, the gearwheel 40, which is connected to the bearing plate 31 of the respective carousel 2, is formed as an externally toothed ring gear. The drive movement of the carousel drive 3 is transmitted to the bearing plate 31, which is positioned within the gearwheel 40, by way of the gearwheel 39 that engages externally on the gearwheel 40.

These embodiments of the bristle goods manufacturing machine 1 do require a gearwheel 40 with a comparatively large diameter. However, in these embodiments, no feedthrough of a drive train from the carousel drive 3 to the bearing plate 31 through a bearing block 41 of the carousel 2 is required. Corresponding feedthroughs are provided in the bristle goods manufacturing machines 1 shown in the other figures.

In the bristle goods manufacturing machines 1 shown in FIGS. 7-12, the gearbox 33 with its gearwheels 39 and 40 allows not only the transmission of the drive movement of the carousel drive 3, but also a particularly small mutual spacing of the holders 5 on the bearing plate 31, and thus a compact design of the carousel 2.

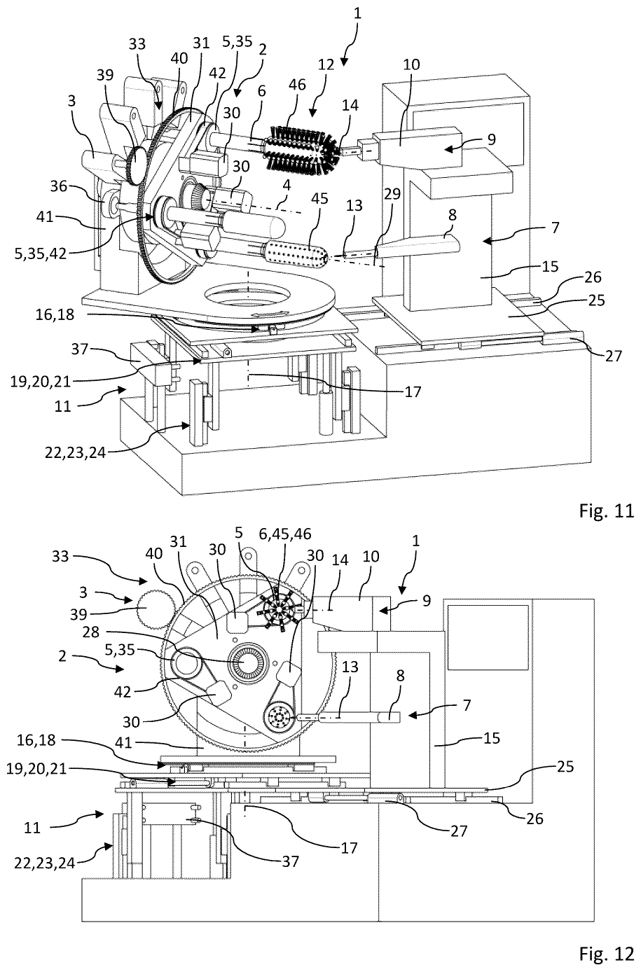

In the bristle goods manufacturing machine shown in FIGS. 11 and 12, three holder drives 30 are disposed on the bearing plate 31. One of the holder drives 30 is in each case assigned to one of the holders 5. The holder drives 30 are connected to the holders 5 assigned to them by way of drive belts 42. The holder drives 30 on the bearing plate 31 are supplied with both current and control signals by way of the rotary feedthrough 28 of the carousel 2.

The bristle goods manufacturing machine 1 shown in FIGS. 9 and 10 has a gearbox 33 configured as a transfer case 34. The single external holder drive 30, which is disposed on the bearing block 41 and thus not on the rotating bearing plate 31, is for driving connected to each of the three rotatably mounted holders 5 by way of the transfer case 34. In addition to the gearwheel 39, the transfer case 34 also has an idler gearwheel 44 formed as a double-toothed ring gear and further gearwheels 43 which are in each case connected to the holders 5.

In the bristle goods manufacturing machines 1 shown in FIGS. 1-6, the gearwheels 43 on the holders 5 are connected to the gearwheels 39 on the holder drives 30 by way of the idler gearwheels 44 disposed on the gearbox shafts 50. The gearbox shafts 50 are rotatably mounted in the bearing block 41. The gearwheels 39 of the bristle goods manufacturing machines 1 shown in FIGS. 1-6 are driven directly by the holder drives 30.

The holders 5 of the bristle goods manufacturing machine 1 shown in FIGS. 7-12 are configured as clamps 35. The bristle goods manufacturing machines 1 shown in these figures serve for manufacturing toilet brushes.

FIG. 8 shows that the gearwheels 43 on the holders 5 are configured as ring gears. This makes it possible to insert the bristle goods bodies 6 through the gearwheels 43, which facilitates a compact configuration of the bristle goods manufacturing machine 1. In this way, even long-handle bristle goods bodies 6 of toilet brushes can be received in a space-saving manner. The bristle goods bodies 6 inserted into the gearwheels 43 thus protrude beyond the front side of the bearing plate 31 of the carousel 2 to a lesser degree.

The bristle goods manufacturing machines 1 shown in FIGS. 9 and 10 and 11 and 12 have in each case an operating unit 36. With the aid of the operating unit 36, the clamps 35 of the holders 5 moved into the loading and/or unloading station 11 of the bristle goods manufacturing machine 1 can be opened. The completed bristle goods 12 can be retrieved from the opened clamps 35. The opened clamps 35 on the holders 5 can thereafter be populated with bristle goods bodies 6 to be processed.

In the bristle goods manufacturing machine 1 shown in FIGS. 9 and 10, the operating unit 36 is also specified to decouple a drive connection between the holder 5, which is located in each case in the loading and/or unloading station 11, and the holder drive 30. This is expedient, since in this embodiment of the bristle goods manufacturing machine 1 a single external holder drive 30 is provided, which for driving is connected to each of the three holders 5 by way of the gearbox 33 and its gearwheels 39, 43 and 44. The idler gearwheel 44 of this gearbox 33, which is configured as transfer case 34, is an internally and externally toothed ring gear. The gearwheels 43 connected to the holders 5 are disposed within the idler gearwheel 44 and engage in the internal toothing of the idler gearwheel 44. The idler gearwheel 44 is driven by the holder drive 3 by way of the gearwheel 39 which meshes with the external teeth of the idler gearwheel 44.

In order to prevent that the holder 5 located in the loading and/or unloading station 11 rotates conjointly with the other holders 5 while loading or while retrieving, or else that the holders 5 have to be stopped at the drilling station 7 and the stuffing station 9, decoupling of the drive connection is expedient.

Each of the bristle goods manufacturing machines 1 shown in the figures has a gripper 37 in the loading and/or unloading station 11, which is specified both for retrieving completed bristle goods 12 and for populating the holders 5 with bristle goods bodies 6.

For absorbing forces occurring during the processing of the bristle goods bodies 6, the bristle goods manufacturing machine 1 shown in FIGS. 1 to 4 and 13 has a locking device 47 for the carousel 2. The locking device 47 is configured as a mechanical locking device and comprises a locking bolt 48 on the bearing block 41 of the carousel 2, and three locking notches 49 on the bearing plate 31 of the carousel 2. In order to lock the carousel 2, the locking bolt 48 engages in the locking notch 49 which is disposed between the holders 5 located in the drilling station 7 and in the stuffing station 9.

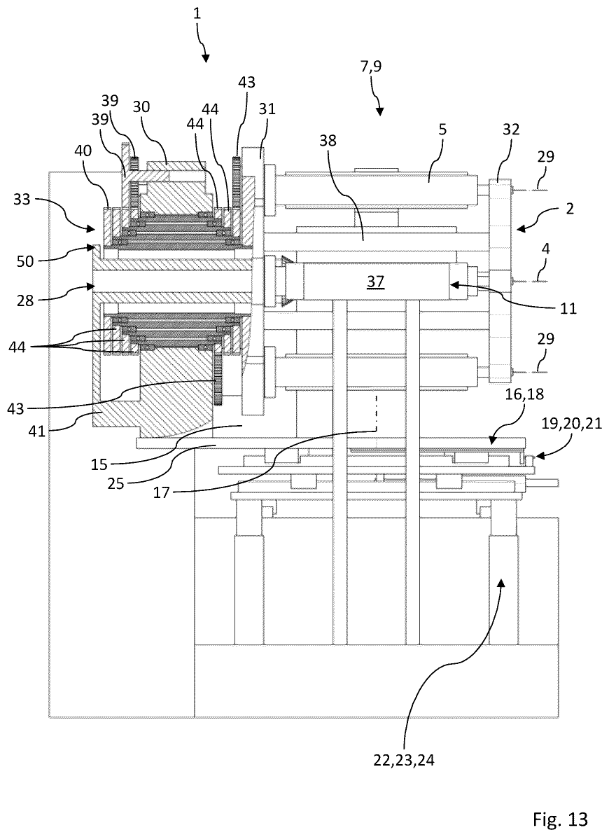

FIG. 13 shows a partially sectional lateral view of the bristle goods manufacturing machine 1 shown in FIGS. 1-4. The partially sectional illustration of the bristle goods manufacturing machine 1 shows the construction of the gearbox 33 between the carousel drive 3 and the carousel 2 with its bearing plate 31 and the three holder drives 30 and the rotatably mounted holders 5.

FIG. 13 shows that the idler gearwheels 44 are disposed on gearbox shafts 50. The gearbox shafts 50 are rotatably mounted in the bearing block 41 and enable the drive movement from the carousel drive 3 to be transmitted to the bearing plate 31 of the carousel 2, and from the holder drives 30 to the rotatably mounted holders 5. On both sides of the bearing block 41, each gearbox shaft 50 supports in each case one idler gearwheel 44.

The idler gearwheels 44 located on the left side of the bearing block 41 in FIG. 13 mesh in each case with one of the gearwheels 39 which are driven by the carousel drive 3 or by one of the holder drives 30, respectively.

The drive movements of the drives 3 and 30 can be transmitted to the idler gearwheels 44, shown on the right side of the bearing block 41, through the bearing block 41 by way of the gearbox shafts 50.

The drive movements are picked up there by way of the gearwheels 43 on the holders 5, or by way of the gearwheel 40 which is connected to the bearing plate 31, respectively.

### LIST OF REFERENCE SIGNS

1 Bristle goods manufacturing machine
2 Carousel
3 Carousel drive
4 Rotation axis
5 Holder
6 Bristle goods body
7 Drilling station
8 Drilling tool
9 Stuffing station
10 Stuffing tool
11 Loading and/or unloading station
12 Bristle goods
13 Feed axis
14 Stuffing axis
15 Stand
16 Pivoting device
17 Pivot axis
18 Pivot drive
19 Horizontal adjustment device
20 Horizontal adjustment drive
21 Horizontal guide
22 Lifting device
23 Lifting drive
24 Lifting axis
25 Slide
26 Slide guide
27 Slide drive
28 Rotary feedthrough
29 Holder rotation axis
30 Holder drive
31 Bearing plate
32 Counter bearing plate
33 Gearbox
34 Transfer case
35 Clamp
36 Operating unit
37 Gripper
38 Connecting strut
39 Gearwheel
40 Gearwheel
41 Bearing block
42 Drive belt
43 Gearwheel on 5
44 Idler gearwheel
45 Hole in 6
46 Bristle bundle
47 Locking device
48 Locking bolt
49 Locking notch
50 Gearbox shaft

1. A bristle goods manufacturing machine (1), comprising:
a carousel (2) on which are provided at least three holders (5) for receiving bristle goods bodies (6), said holders are disposed successively in a rotation direction of the carousel (2);
a carousel drive (3) adapted to rotatably drive the carousel (2) about a rotation axis (4);
at least one drilling station (7) with a drilling tool (8);
at least one stuffing station (9) with a stuffing tool (10);
at least one loading and/or unloading station (11) for loading and/or unloading the holders (5);
wherein a feed axis (13) of the drilling tool (8) and a stuffing axis (14) of the stuffing tool (10) are aligned parallel to one another; and
a pivoting device (16) including a pivot axis (17) and a pivot drive (18) for the carousel (2), and the pivot axis (17) is aligned orthogonally to the rotation axis (4) of the carousel (2).

2. The bristle goods manufacturing machine (1) as claimed in claim 1, further comprising: a locking device (47) for the carousel (2); and a common stand (15), on which the drilling tool (8) and the stuffing tool (10) are disposed.

3. The bristle goods manufacturing machine (1) as claimed in claim 1, wherein the rotation axis (4) of the carousel (2) is disposed in a plane between the feed axis (13) of the drilling tool (8) and the stuffing axis (14) of the stuffing tool (10), and/or in a plane which is parallel to the feed axis (13) of the drilling tool (8) and the stuffing axis (14) of the stuffing tool (10).

4. The bristle goods manufacturing machine (1) as claimed in claim 1, wherein the rotation axis (4) of the carousel (2), the feed axis (13) of the drilling tool (8), and the stuffing axis (14) of the stuffing tool (10) are horizontally aligned.

5. The bristle goods manufacturing machine (1) as claimed in claim 1, wherein the holders (5) are disposed on the carousel (2) uniformly distributed about the rotation axis (4) of the carousel (2).

6. The bristle goods manufacturing machine (1) as claimed in claim 1, further comprising: a horizontal adjustment device (19) with a horizontal adjustment drive (20) and a horizontal guide (21) which is oriented orthogonally to the feed axis (13) of the drilling tool (8) and the stuffing axis (14) of the stuffing tool (10) and along which the carousel (2) is able to be positioned.

7. The bristle goods manufacturing machine (1) as claimed in claim 1, further comprising: a lifting device (22) with a lifting drive (23) and a vertically oriented lifting axis (24) along which the carousel (2) is height-adjustable.

8. The bristle goods manufacturing machine (1) as claimed in claim 1, further comprising: a slide (25) on which the drilling tool (8) and the stuffing tool (10) are conjointly disposed.

9. The bristle goods manufacturing machine (1) as claimed in claim 8, wherein the slide (25) is mounted to be linearly displaceable in a slide guide (26) which is oriented parallel to the feed axis (13) of the drilling tool (8) and parallel to the stuffing axis (14) of the stuffing tool (10).

10. The bristle goods manufacturing machine (1) as claimed in claim 8, further comprising a slide drive (27) by which the slide (25) is linearly displaceable in the slide guide (26).

11. The bristle goods manufacturing machine (1) as claimed in claim 1, wherein the carousel (2) has a rotary feedthrough (28) for electrical and/or pneumatic supply to functional units located on the carousel (2).

12. The bristle goods manufacturing machine (1) as claimed in claim 1, wherein the holders (5) are in each case mounted on the carousel (2) so as to be rotatable about a holder rotation axis (29) which is oriented parallel to the rotation axis (4) of the carousel (2), and each of the holders (5) is adapted to receive two or more bristle goods bodies (6).

13. The bristle goods manufacturing machine (1) as claimed in claim 1, wherein the carousel (2) has a bearing plate (31) on which the holders (5) are rotatably mounted.

14. The bristle goods manufacturing machine (1) as claimed in claim 13, wherein the carousel drive (3) for driving is connected to the bearing plate (31) by a gearbox (33).

15. The bristle goods manufacturing machine (1) as claimed in claim 12, further comprising: at least one holder drive (30), and the holder drive (30) is disposed outside the carousel (2) or on the carousel (2).

16. The bristle goods manufacturing machine (1) as claimed claim 15, wherein a plurality of the holders (5) are driven by the at least one holder drive (30), or wherein each said holder (5) is assigned one of the at least one holder drives (31).

17. The bristle goods manufacturing machine (1) as claimed in claim 1, further comprising: a holder drive (30) which for driving is connected to at least two of the holders (5) by way of a gearbox (33) configured as a transfer case (34).

18. The bristle goods manufacturing machine (1) as claimed in claim 1, wherein the holders (5) have in each case at least one clamp (35) for bristle goods bodies (6) and/or bristle goods (12).

19. The bristle goods manufacturing machine (1) as claimed in claim 1, further comprising: an operating unit (36) which is adapted to decouple a drive connection to one of the holders (5) located in the loading and/or unloading station (11), and/or to open a clamp (35) of one of the holders (5) located in the loading and/or unloading station (11).

20. The bristle goods manufacturing machine (1) as claimed in claim 1, wherein the loading and/or unloading station (11) has a gripper (36) for retrieving finished bristle goods (12) and/or for loading the holders (5) with bristle goods bodies (6).
